(19) United States
(12) Patent Application Publication
(10) Pub. No.: US 2022/0261431 A1
(43) Pub. Date: Aug. 18, 2022

(54) AN APPLICATION PREFERENCE TEXT CLASSIFICATION METHOD BASED ON TEXTRANK

(71) Applicant: Beijing Digital Union Web Science and Technology Company Limited, Beijing (CN)

(72) Inventors: Haiting Wang, Beijing (CN); Congan Yang, Beijing (CN)

(21) Appl. No.: 16/621,620

(22) PCT Filed: Nov. 15, 2019
(86) PCT No.: PCT/CN2019/118626

§ 371 Date: Dec. 11, 2019

(30) Foreign Application Priority Data
Nov. 13, 2019 (CN) 201911106117.7

(51) Int. Cl. G06F 16/35

(52) U.S. Cl. CPC G06F 16/353

(57) ABSTRACT

This invention provides an application preference text classification method based on TextRank, including the steps as follows: generate keywords of each App according to the TextRank algorithm to form a first keywords stock; indicate a seed keyword for each sub-category according to the plurality of sub-categories; get the Apps including the seek keywords from the first keywords stock by fuzzy searching according to the seed keywords and indicate such Apps with sub-categories; conduct full calculation for the seek keywords of all Apps under the sub-categories by the TextRank algorithm and generate the second keywords stock under a plurality of sub-categories; traverse the list of Apps again and compare the contents of each keyword with the second keywords stock in the similarity of character strings; if the similarity is lower than the preset threshold, delete the association between the Apps and the current sub-categories. This invention can study by itself and gradually remove the unconcerned keywords according to the effect of core keyword generation to improve the accuracy.

### TECHNICAL FIELD

This invention relates to the field of mobile Internet, in particular to an application preference text classification method based on TextRank, an electronic device and a computer storage medium.

### BACKGROUND ART

In the field of mobile Internet, the application classification of Apps is based on the application of artificial classification and feature extraction, and the sample base is used as the training set to build the classification model according to the feature application.

The disadvantages of the existing classification model: it needs a lot of manual marking and labeling, and sometimes the marking & labeling is not accurate or complete, which will lay a hidden danger for the subsequent supervision and learning; it cannot learn by itself nor adapt to the changes of the text and generate the best categories. In the process of text classification, we often need to invest a lot of manpower and time to organize the training set, which will cost a lot of time and money, and generate inevitable errors.

### CONTENTS OF THE INVENTION

The purpose of this invention is realized by the technical scheme as follows.

This invention aims to make the keywords under the categories more and more concentrated and accurate by repeatedly extracting and correcting the subject words. This invention provides an unsupervised way of training, which does not rely on manual classification and screening and uses algorithm to generate features. In the verification process, the classified data is extracted again and checked repeatedly, making the model more and more accurate.

To achieve the above purpose, the first embodiment of the application proposes an application preferred text classification method based on TextRank, including the steps as follows:

S1: Generate keywords of each App according to the TextRank algorithm to form a first keywords stock;

S2: Indicate a seed keyword for each sub-category according to the plurality of sub-categories;

S3: Get the Apps including the seek keywords from the first keywords stock by fuzzy searching according to the seed keywords and indicate such Apps with sub-categories;

S4: Conduct full calculation for the seek keywords of all Apps under the sub-categories by the TextRank algorithm and generate the second keywords stock under a plurality of sub-categories;

S5: Traverse the list of Apps again and compare the contents of each keyword with the second keywords stock in the similarity of character strings; if the similarity is lower than the preset threshold, delete the association between the Apps and the current sub-categories.

According to one embodiment of this invention, the plurality of the sub-categories are the accepted 75 categories in the field of APP classification.

According to one embodiment of this invention, the preset threshold is 70% or 75%.

According to one embodiment of this invention, the method includes:

S6: After traversing the list of Apps, regenerate the second keywords stock and repeat the steps S1-S5.

According to one embodiment of this invention, the method includes:

S7: Check the accuracy manually according to the final generation result; if the effect is not ideal, continue to repeat the steps S1-S5.

To achieve the above purpose, the second embodiment of the application proposes an electronic device, comprising: memory, processor and computer program which is stored in the memory and can run in the processor, and will be executed to realize the method stated when the processor operates the computer program.

To achieve the above purpose, the third embodiment of the application proposes a computer-readable storage medium with computer program, and will be executed to realize any method in claims 1-5 when the processor operates the computer program.

The advantages of this invention include:

1. It needs less manpower and time and simple manual sorting of relevant keywords;

2. It supports self-learning and can gradually remove the unconcerned keywords as per the effect of core keyword generation;

3. It allows manual regulation of core keywords, further improving the accuracy.

### BRIEF DESCRIPTION OF THE DRAWINGS

By reading the details of the selected execution modes below, the common technicians of this field will be clear of all advantages and benefits. The figures are only used to show the purposes of the selected execution modes rather than restrict this invention. In addition, in the whole figures, the same reference symbols shall be used to represent the same parts. In the figures:

FIG. 1 shows the flowchart of an application preference text classification method based on TextRank according to the execution modes of this invention;

FIG. 2 shows the structural diagram of an electronic device provided by an embodiment of this invention;

FIG. 3 shows the schematic diagram of a computer medium provided by an embodiment of this invention.

### EMBODIMENTS

We will describe the typical execution modes in detail with the reference to the figures. Though the figures show the typical execution modes of this invention, we shall understand that this invention can be realized in all forms rather than be restricted by the execution mode herein. On the contrary, these execution modes are provided with the purpose to make this invention more understandable and transmit the scope of this invention to the technicians of this field. Noted that unless otherwise specified, the technical terms or scientific terms used in this invention shall be the general meaning understood by the technicians of this field.

In addition, the terms “first”, “second” and the like are used to distinguish different objects rather than to describe a particular order. In addition, the terms “include”, “have” and their deformations are intended to cover the non-exclusive inclusions. For example, the processes, methods, systems, products or devices that contain a series of steps or units are not limited to the listed steps or units, but optionally also include the steps or units that are not listed, or optionally include other steps or units that are fixed to these processes, methods, products or devices.

This invention aims to make the keywords under the categories more and more concentrated and accurate by repeatedly extracting and correcting the subject words. This invention provides an unsupervised way of training, which does not rely on manual classification & screening and uses algorithm to generate features. In the verification process, the classified data is extracted again and checked repeatedly, making the model more and more accurate.

TextRank: this algorithm is a graph-based sorting algorithm for text. Its basic idea comes from Google's PageRank algorithm. By dividing the text into several constituent units (words, sentences) and building a graph model, it uses voting mechanism to sort the important components in the text, and only uses the information of a single document itself to achieve keyword extraction.

Application preference: it is a new category of App on the user preference level. Different from most app stores, this classification is closer to interests and hobbies, such as car enthusiasts and music lovers.

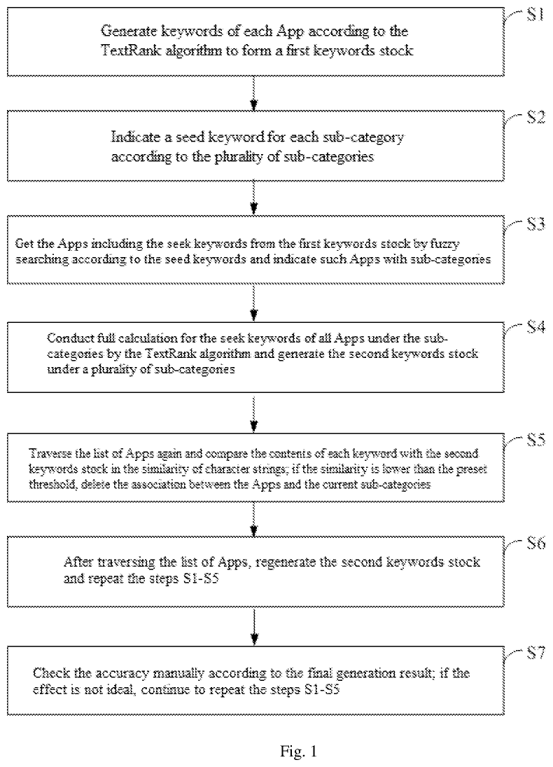

As shown in FIG. 1, an application preferred text classification method based on TextRank of this invention includes the steps as follows:

S1: Generate the keywords of each App according to the TextRank algorithm and form the first keywords stock.

S2: Indicate a seed keyword for each sub-category according to the known plurality of sub-categories. The sub-categories stated are the accepted 75 categories in the field of application classification.

S3: Get the Apps including the seek keywords from the first keywords stock by fuzzy searching according to the seed keywords and indicate such Apps with sub-categories.

S4: Conduct full calculation for the seek keywords of all Apps under the sub-categories by the TextRank algorithm and generate the second keywords stock under a plurality of sub-categories.

S5: Traverse the list of Apps again and compare the contents of each keyword with the second keywords stock in the similarity of character strings; if the similarity is lower than the preset threshold (e.g.70%), we will consider the Apps aren't related to the current categories and delete the association between the Apps and the current categories i.e. the correspondences of the Apps to categories.

S6: After traversing the list of Apps, regenerate the second keywords stock and repeat the steps S1-S5;

S7: Check the accuracy manually according to the final generation result; if the effect is not ideal, continue to repeat the steps.

### Embodiment 1

S11: Generate keywords stock-1 corresponding to each App information by the TextRank algorithm, as shown in the keywords in the table below:

Keywords stock-1:

| App_name | Key_words | Cate_id | Cate_name | Sub_cate_id | Sub_cate_name | Description |
|---|---|---|---|---|---|---|
| Tubatu | Decoration, | 2 | Decoration | 12 | Decoration and | Tubatu for |
| decoration | Service, | | supplies | | building materials | decoration, |
| | Company, | | | | | providing one-stop |
| | WOM, | | | | | decoration services. |
| | Owner, | | | | | Enjoy decoration |
| | Furnishing, | | | | | services without |
| | Capital, | | | | | leaving home. |
| | User, | | | | | Tubatu: 11-year |
| | Whole | | | | | brand for |
| | Process, | | | | | decoration. |
| | Case, | | | | | |
| | Guarantee, | | | | | |
| | Tuba, | | | | | |
| | Scheme, | | | | | |
| | Quotation, | | | | | |
| | Sector, | | | | | |
| | Provide, | | | | | |
| | Free, | | | | | |
| | Professional, | | | | | |
| | Decoration, | | | | | |
| | Indicator | | | | | |
| . . . | . . . | . . . | . . . | . . . | . . . | . . . |

S12: Indicate each category with seed keywords according to the known 75 sub-categories; only one needs to be indicated, which is detailed in Table-3;

S13: Get the Apps including seed keywords from the keywords stock-1 by fuzzy search according to the seed keywords and indicate them with sub-categories;

S14: Generate the core keywords corresponding to the 75 sub-categories by using TextRank algorithm on all seed keywords of the 75 sub-categories according to the first keywords stock to form the core keywords stock-2 under the categories;

S15: Judge the keywords generated from each App information with the keywords of its category in similarity using the core keywords stock-2; if the similarity is lower than 0.75, the App will be not related to the category and the association shall be deleted;

S16: After traversing, regenerate the core keywords stock-2 and continue the previous steps;

S17: Check the accuracy manually according to the final generation result; if the effect is not ideal, continue to repeat the steps.

Core keywords stock-2 (the words with digital marks in the former two ranks are
categories and sub-categories of application preference and the remaining words
are the keywords generated by TextRank)

2 decoration supplies, 12 decoration building materials, building materials, building materials,
furnishing, professional, service, platform, provide, design, information, user, function,
enterprise, sector, decoration, optimize, forge, product, release, quotation
2 furnishing supplies, 13 home furnishings & textile, furnishing, furnishing, decoration, design,
life, share, provide, platform, function, user, designer, product, commodity, brand, experience,
optimize, service, shopping, furniture, information
2 furnishing supplies, 14 home appliances, appliances, appliances, chargers, mobile phone,
function, use, charge, battery, intelligent App, device, control, product, optimize, commodity,
user, automatic, experience, provide, system
2 furnishing supplies 15 home appliances repair, repair, repair, service, automobile, provide,
function, information, user, optimize, professional, platform, mobile phone, maintenance,
fittings, vehicle owner, query, vehicle, appointment, life, increase
2 furnishing supplies 16 daily supplies, supplies, supplies, commodity, shopping,
coupon ,service, mother & baby, life, provide, repair, digital, optimize, economic, daily
supplies, product, consumption, search, experience, user, supermarket
3 financial product management, 17 stock fund, stock, stock, investment, exchange, provide,
market situation, stock speculation, information, service, securities, user, data, function, stock
market, optimize, intelligent, analysis, finance, information
3 financial product management 18 insurance, insurance, insurance, service, provide, user,
product,function, information, platform, optimize, query, insurer, intelligent, guarantee,
customer, professional, automobile, claim, experience, management
3 financial product management, 19 lottery, lottery, lottery, function, data, provide, analysis,
mobile phone, number, trend, information, query, recommend, optimize, professional, new,
predict, for free, lottery player, all-around, software
3 financial product management 20 future exchange, future, future, market situation, exchange,
investment, information, provide, gold, crude oil, foreign exchange, optimize, user, noble metal,
service, software, professional, account opening, finance and economics, spot commodity,
finance
3 financial product management, 21 bank product management, product management, product
management, investment, platform, finance, service, user, capital, bank, provide, optimize,
income, function, product, Internet, management, professional, exchange, fund, assets
3 financial product management, 22 Internet finance, online loan, online loan, platform, finance,
user, investment, service, product management, capital, information, product, Internet, bank,
data, assets, loan, China, optimize, credit, provide
3 financial product management, 23 noble metal, noble metal, noble metal, investment, market
situation, exchange, provide, future, information, gold, crude oil, user, foreign exchange, spot
commodity, capital, optimize, tactic, analysis, service, account opening
4 education & training, 24 pre-school education, education, child, child, education, kid, game,
learn, story, nursery rhythms, product, enlighten, infant, content, focus, early education, grow,
literary, brand, cartoon, child, classics
4 education & training, 25 primary and secondary education, primary, education, primary,
education, learn, student, teacher, application, teach, no, develop, practice, condition, provide,
math, video, child, support, fun, review, interface display
4 education & training, 26 high-level education, university, education, education,
undergraduate, function, optimize, platform, intern, part-time job, application, operate, pay,
diverse types, etiquette, service, resource, research, promote, clock, university, provide
4 education & training, 27 vocational education, vocation, education, education, vocation,
training, exam, course, learn, knowledge, service, professional, question bank, develop, tutor,
experience, student, provide, repair, enterprise, vocational qualification, paper
4 education & training, 28 degree education, degree, education, exam, degree, education,
knowledge point, vocational qualification, training, recruit, become, cover, item, intelligent,
continue, teach, help, subject, finance & economics, certify, tutor, improve
4 education & training, 29 language training, English, learn, English word, word, function,
pronounce, provide, help, use, content, English listening, translate, practice, exam, software,
question, primary, optimize, contain, memory
4 education & training, 30 IT training, programing, training, service, course, programing,
training, contain, institute, provide, classics, choice question, user, C language, upgrade, exam
point, function, software, solve, question bank, query, key point
5 travel, 31 local travel, local, travel, travel, information, lodging, surrounding area, place,
provide, entertainment, park, strategy, trip, tourist, necessity, event, event, application, related,
download, include, activity
5 travel, 32 travel at home, home, travel, travel, travel at home, route, strategy, travel abroad,
navigation, hotel, product, column, get, go out, application, necessity, cover, practical
information, query, flight, coupon, book
5 travel, 33 travel in HK & Macao & Taiwan, HK, travel, HK, travel, provide, function, product,
map, preferential, scenic spot, trip, merchant, route, ticket, information, world, book, discount,
positioning, include, resort
5 travel, 34 travel overseas, overseas, travel, video, function, country, call, repair, travel
overseas, sudden status, tourist, provide, improve, deal with, translate, guider, route, web phone,
add, individual, travel, itinerary

TABLE 3
Seed keywords with manual marks:

| Category | Category name | Sub-category | Sub-category name | Seed keywords |
|---|---|---|---|---|
| 2 | Decoration | 12 | Decoration and building | Building material |
| | supplies | | material | |
| 2 | Decoration | 13 | Furnishing & textile | Furnishing |
| | supplies | | | |
| 2 | Decoration | 14 | Home appliance | Appliance |
| | supplies | | | |
| 2 | Decoration | 15 | Home appliance repair | Repair |
| | supplies | | | |
| 2 | Decoration | 16 | Daily supplies | Supplies |
| | supplies | | | |
| 3 | Financial | 17 | Stock fund | Stock |
| | product | | | |
| | management | | | |
| 3 | Financial | 18 | Insurance | Insurance |
| | product | | | |
| | management | | | |
| 3 | Financial | 19 | Lottery | Lottery |
| | product | | | |
| | management | | | |
| 3 | Financial | 20 | Future exchange | Future |
| | product | | | |
| | management | | | |
| 3 | Financial | 21 | Bank product | Product |
| | product | | management | management |
| | management | | | |
| 3 | Financial | 22 | Internet finance | Online loan |
| | product | | | |
| | management | | | |
| 3 | Financial | 23 | Noble metal | Noble metal |
| | product | | | |
| | management | | | |
| 4 | Education and | 29 | Language training | English |
| | training | | | |
| 5 | Travel | 31 | Local travel | Local |
| 5 | Travel | 33 | Travel in HK & | HK |
| | | | Macao & Taiwan | |
| 5 | Travel | 34 | Travel overseas | Overseas |
| 5 | Travel | 35 | Outdoor adventure | Adventure |
| 5 | Travel | 37 | Lodging in hotel | Lodging |
| 5 | Travel | 38 | Traffic ticket service | Ticket service |
| 6 | Garments & | 39 | Fashion women clothes | Women clothes |
| | bags | | | |
| 6 | Garments & | 40 | Best men clothes | Men clothes |
| | bags | | | |
| 6 | Garments & | 41 | Women shoes | Women shoes |
| | bags | | | |
| 6 | Garments & | 42 | Men shoes | Men shoes |
| | bags | | | |
| 6 | Garments & | 43 | Underclothes | Underclothes |
| | bags | | | |
| 6 | Garments & | 44 | Jewelry accessories | Jewelry |
| | bags | | | |
| 6 | Garments & | 45 | Children clothes & | Children clothes |
| | bags | | shoes | |
| 6 | Garments & | 46 | Bags & accessories | Bags |
| | bags | | | |
| 6 | Garments & | 47 | Watch | Watch |
| | bags | | | |
| 8 | Cosmetics | 54 | Slimming | Slimming |
| 8 | Cosmetics | 55 | Cosmetic surgery | Cosmetology |
| 8 | Cosmetics | 56 | Hairdressing | Hairdressing |
| 8 | Cosmetics | 57 | Cosmetic and skin care | Cosmetic |
| 10 | Food and | 63 | Restaurant | Restaurant |
| | beverage | | | |
| 10 | Food and | 64 | Cooking products | Cooking |
| | beverage | | | |
| 10 | Food and | 65 | Snacks | Snacks |
| | beverage | | | |
| 10 | Food and | 66 | Fruits and vegetables | Fruits |
| | beverage | | | |
| 10 | Food and | 67 | Other fresh products | Fresh products |
| | beverage | | | |
| 10 | Food and | 68 | Breads and cakes | Cakes |
| | beverage | | | |
| 10 | Food and | 69 | Drinks | Drinks |
| | beverage | | | |
| 10 | Food and | 70 | Alcohol and other | Alcohol and other |
| | beverage | | drinks | drinks |
| 10 | Food and | 71 | Imported food | Food |
| | beverage | | | |
| 11 | Mother, baby, | 72 | Maternal supplies | Maternal |
| | child | | | |
| 11 | Mother, baby, | 73 | Fetal education related | Fetal education |
| | child | | | |
| 11 | Mother, baby, | 74 | Baby supplies | Baby |
| | child | | | |
| 14 | Life service | 91 | Beauty and hairdressing | Beauty |
| 14 | Life service | 92 | Housekeeping | Housekeeping |
| 14 | Life service | 93 | Camera service | Camera |
| 14 | Life service | 94 | Pet supplies | Pet |
| 15 | Medical health | 97 | Adult products | Adult |
| 15 | Medical health | 98 | Health products | Health products |
| 15 | Medical health | 99 | Medical apparatus and | Medical |
| | | | instruments | |
| 15 | Medical health | 100 | Drugs | Drugs |
| 15 | Medical health | 101 | Medical diagnosis and | Diagnosis and |
| | | | treatment | treatment |
| 16 | Legal services | 102 | Judicial expert | Judicial |
| | | | testimony | |
| 16 | Legal services | 103 | Lawyer service | Lawyer |
| 16 | Legal services | 104 | Notarization | Notarization |
| 17 | Cultural | 105 | Cartoon related | Cartoon |
| | entertainment | | | |
| 17 | Cultural | 106 | BRPG | BRPG |
| | entertainment | | | |
| 17 | Cultural | 107 | Film & TV | TV |
| | entertainment | | | |
| 17 | Cultural | 108 | Art exhibition | Art |
| | entertainment | | | |
| 17 | Cultural | 109 | Show | Show |
| | entertainment | | | |
| 17 | Cultural | 110 | Pub & KTV | Pub |
| | entertainment | | | |
| 17 | Cultural | 111 | Favorite collecting | Favorite |
| | entertainment | | | |
| 17 | Cultural | 112 | Books and magazines | Books |
| | entertainment | | | |
| 18 | Business | 113 | Office supplies | Office |
| | service | | | |
| 18 | Business | 114 | Job hunting & | Job hunting |
| | service | | recruitment | |
| 18 | Business | 115 | Immigration | Immigration |
| | service | | intermediary | |
| 18 | Business | 116 | Mechanical equipment | Mechanical |
| | service | | | |
| 18 | Business | 118 | Chemical materials | Chemical |
| | service | | | |
| 18 | Business | 119 | Energy conservation | Environment |
| | service | | and environment | protection |
| | | | protection | |
| 18 | Business | 120 | Safety and security | Security |
| | service | | | |
| 18 | Business | 121 | Logistics distribution | Logistics |
| | service | | | |
| 18 | Business | 122 | Marketing ad | Ad |
| | service | | | |
| 18 | Business | 123 | Exhibition service | Exhibition |
| | service | | | |
| 18 | Business | 124 | Merchant & franchise | Merchant |
| | service | | | |

The final text classification results are as follows:

| id | package_name | app_name | key_words | cate_id | cate_name | sub_cate_name | sub_cate_id | tag |
|---|---|---|---|---|---|---|---|---|
| 1 | com.touchwaves.fuling | www.fuling.com | Fuling, information, post, | 2 | Decoration | Decoration | 12 | \N |
| | | | website, publish, hot point, | | supplies | and | | |
| | | | channel, new, furnishing, | | | building | | |
| | | | wedding, food, news, | | | material | | |
| | | | push, automobile, | | | | | |
| | | | gathering, professional, | | | | | |
| | | | ranking, client, function, | | | | | |
| | | | increase | | | | | |
| 5 | com.house365.jj | House 365 | Special price, furniture, | 2 | Decoration | Decoration | 12 | \N |
| | | | furnishings, affordable, | | supplies | and | | |
| | | | online supermarket, home | | | building | | |
| | | | ornament, include, | | | material | | |
| | | | decoration, economic, | | | | | |
| | | | user, enjoy, product, | | | | | |
| | | | building material, special | | | | | |
| | | | price product, at hand, | | | | | |
| | | | seek | | | | | |
| 6 | com.goojje.app4 | Online | Construction, hardware, | 2 | Decoration | Decoration | 12 | \N |
| | 31f3b0d62f4528 | building | best choice, enterprise, | | supplies | and | | |
| | b033990ed6038 | material & | trade, e-commerce, | | | building | | |
| | 7b85 | hardware | provide, building material, | | | material | | |
| | | | application, platform, | | | | | |
| | | | material, decoration | | | | | |
| | | | hardware, professional, | | | | | |
| | | | hardware decoration, | | | | | |
| | | | quotation, support, | | | | | |
| | | | settlement, seek, | | | | | |
| | | | exchange, expect | | | | | |
| 9 | com.naddn.mall | Gediao Lejia | Decoration, function, | 2 | Decoration | Decoration | 12 | \N |
| | | | platform, furniture, design, | | supplies | and | | |
| | | | soft decoration, design | | | building | | |
| | | | program, service, scheme, | | | material | | |
| | | | personalize, building | | | | | |
| | | | material, owner, style, | | | | | |
| | | | construction, designer, | | | | | |
| | | | follow-up, furnishing, | | | | | |
| | | | useful, Lejia, pay | | | | | |
| 10 | com.hcxygjjg.kuaixiu | Dingguang | Decoration, furnishing, | 2 | Decoration | Decoration | 12 | \N |
| | | Robot | share, reconstruction, life, | | supplies | and | | |
| | | | experience, construction, | | | building | | |
| | | | social, designer, design, | | | material | | |
| | | | service, robot, download, | | | | | |
| | | | wonderful content, repair, | | | | | |
| | | | earth, one-key, response, | | | | | |
| | | | quality, building material | | | | | |
| 12 | com.yuanpu.happyhome | Yuejiaju | Furnishing, life, | 2 | Decoration | Decoration | 12 | \N |
| | | | decoration, design, tone, | | supplies | and | | |
| | | | experience, quality, repair, | | | building | | |
| | | | hot point, contain, album, | | | material | | |
| | | | add, spokesman, memory, | | | | | |
| | | | optimize, daily supplies, | | | | | |
| | | | style, bright color, | | | | | |
| | | | flashback, part | | | | | |

The advantages of this invention include:

1. It needs less manpower and time and simple manual sorting of relevant keywords;

2. It supports self-learning and can gradually remove the unconcerned keywords as per the effect of core keyword generation;

3. It allows manual regulation of core keywords, further improving the accuracy.

The execution modes of this invention also provide an electronic device corresponding to the application preference text classification method based on TextRank provided in the aforementioned execution modes to execute the application preference text classification method based on TextRank. The electronic device can be mobile phone, tablet computer and camera, which is not restricted in the embodiments of this invention.

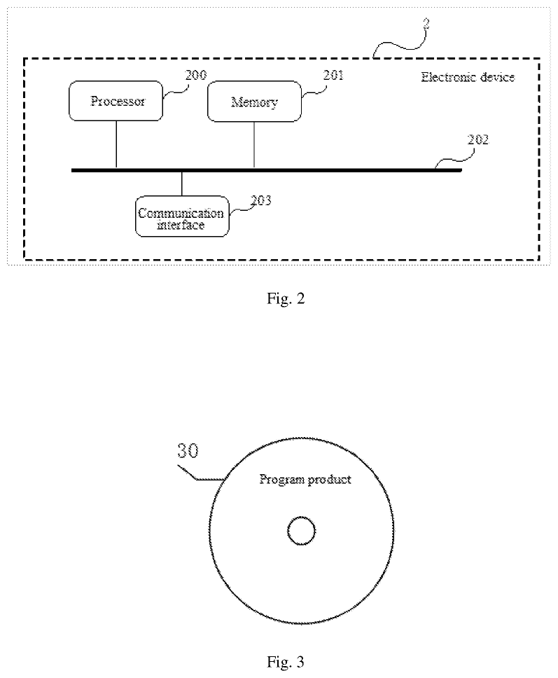

With the reference to FIG. 2 which is the schematic diagram of the electronic devices provided by certain execution modes of this invention, the electronic device 2 comprises the processor 200, the memory 201, the bus 202 and the communication interface 203, and the processor 200, communication 203 and the memory 201 are connected through the bus 202; the memory 201 stores the computer program which can run in the processor 200 and the processor 200 will execute the application preference text classification method based on TextRank provided by any execution mode of this invention when it operates the computer program.

Thereof, the memory 201 may contain high-speed random access memory (RAM) and/or non-volatile memory which may be minimum one disk memory. The system network element may be communicated with minimum the other network element through minimum one communication interface 203 (wire or wireless), making the Internet, WAN, local network and MAN available.

The bus 202 may be ISA bus, PCI bus and EISA bus. The bus can be divided into address bus, data bus, control bus, etc. The memory 201 is used for storing programs, and the processor 200 will execute the programs after receiving the execution instructions. The application preference text classification method based on TextRank disclosed in any execution mode of this invention can be applied to or executed by the processor 200.

The processor 200 may be a kind of integrated circuit chip with signal processing capability. During the execution, each step of the above method can be completed through the integrated logic circuit of the hardware or the instruction in the form of software in the processor 200. The above processor 200 can be general-purpose processor, comprising central processing unit (CPU), network processor (NP), etc.; or a digital signal processor (DSP), ASIC, FPGA or other programmable logic device, discrete gate or transistor logic device, and discrete hardware component, which can realize or execute all methods, steps and logic block diagrams in the embodiments of this invention. The general-purpose processor may be a microprocessor or any conventional processor, which can directly present the completion by the hardware decode processor or by the module of hardware and software in the decode processor combined with the steps of the methods disclosed in the embodiments of this invention. The software module can lie in RAM, FM, ROM, ROMP, EEPROM, MTRR and other mature storage mediums of this field which lie in the memory 201. The processor 200 will read the information of the memory 201 and complete the steps of the above methods combined with its hardware.

The electronic devices provided by the embodiments of this invention and the application preference text classification method based on TextRank provided by embodiments of this invention are of the same inventive concept, and have the same beneficial effect as the method adopted, operated or realized.

The execution modes of this invention also provide a kind of computer-readable mediums corresponding to the application preference text classification method based on TextRank provided by the aforesaid execution modes. With reference to the FIG. 3, the computer-readable storage medium is CD30 with the computer program (i.e. program product) and will execute the application preference text classification method based on TextRank provided by any aforesaid execution modes when the computer program is executed by the processor. Noted that the examples of the computer-readable storage mediums can also include without limitation to, PRAM, SRAM, DRAM, RAM, ROM, EEPROM, FM or other optical and magnetic storage mediums, which is not described herein.

The computer-readable mediums provided by the embodiments of this invention and the application preference text classification method based on TextRank provided by embodiments of this invention are of the same inventive concept, and have the same beneficial effect as the method adopted, operated or realized by the App stored.

In the description of the specification, the reference terms “an embodiment”, “certain embodiments”, “examples”, “specific examples”, or “certain examples” mean the minimum one embodiment or example contained in this invention combined with the specific features, structures, materials or characteristics described this embodiment or example. In this specification, the schematic expression of the above terms does not have to be directed to the same embodiment or example. Moreover, the specific features, structures, materials or characteristics described may be combined in an appropriate manner in any one or more embodiments or examples. In addition, without contradiction, the technicians of this field can combine and assemble different embodiments or examples described in this specification and features of different embodiments or examples.

In addition, the terms “first” and “second” are used to describe purposes only and cannot be understood as indicating or implying relative importance or implying the number of indicated technical features. Thus, the features defined as “first” or “second” may include minimum one such feature, either explicitly or implicitly. In the description of this invention, “multiple” means minimum two, such as two, three, etc., unless otherwise specifically defined.

Any process or method in the flowchart or described in other ways herein can be understood as representing a module, fragment or part of code including one or more executable instructions for implementing the steps of a custom logic function or process, and the scope of the selected embodiments of this invention includes additional implementation, which may follow the sequence of showing or discussion. The functions can be executed in basic synchronous way or by inverse sequence, which shall be understood by the technicians of the field for the embodiments of this invention.

The logics and/or steps represented in a flowchart or otherwise described herein, for example, the priority list of the executable instructions considered for realizing the logic functions can be realized in any computer-readable medium to serve the instruction execution systems, units or devices (e.g. systems based on computer, systems with processor or other systems which can take instructions for instruction execution systems, units or devices and execute these instructions), or work in combination with these instruction execution systems, units or devices. In terms of this specification, “computer-readable medium” may be any unit that may contain, store, communicate, propagate or transmit programs for use by or in combination with instruction execution systems, units or devices. A more specific example (non-exhaustive list) of a computer-readable medium includes: electrical connection section (electronic unit) with one or more cables, portable computer disk case (magnetic unit), RAM, ROM, EPROM/FM, optical fiber unit, and CD-ROM. In addition, the computer-readable medium may even be the paper or other suitable medium on which a program can be printed. The program can be obtained through optical scanning, editing, decoding or even by electronic processing for the paper or other mediums and stored in the computer memory.

It is understood that all parts of this invention can be implemented by hardware, software, firmware, or a combination of them. In the above execution modes, a plurality of steps or methods may be realized by the software or firmware stored in memory and executed by a suitable instruction execution system. For example, if realized by hardware as the another execution mode, any one of the following technologies disclosed in this field or their combination can be executed: discrete logic circuit with logic gate circuit for realizing logic function of data signal, special integrated circuit with suitable combination logic gate circuit, programmable gate array (PGA) and field programmable gate array (FPGA).

The common technicians of this field can understand that all or part of the steps realizing the methods in the above embodiments can be completed by the hardware under the instructions of a program. The program can be stored in a computer-readable storage medium. When the program is executed, one or all steps of the method in embodiments can be included.

In addition, all functional units in each embodiment of this invention can be integrated into one processing module or be physically independent, or integrated into one module each two or more. The integration in the module can be realized by hardware or by functional module of software. If the post-integration module is realized by the functional module of software and sold or used as an independent product, it can be stored in a computer-readable storage medium. The storage medium mentioned above can be ROM, disk or CD. Although the embodiments of this invention have been shown and described above, it can be understood that the above embodiments are exemplary and cannot be understood as the restrictions of this invention. The common technicians of this field can change, modify, replace and transform the embodiments above within the scope of this invention.

The above mentioned is only a preferred specific execution mode of this invention instead of the whole protection scope of this invention. Any change or substitution that a technician familiar with this technical field can get easily from the technical scope disclosed by this invention shall be covered by the protection scope of this invention. Therefore, the protection scope of this invention shall be subject to the protection scope of the claims.

We claim:

1. An application preference text classification method based on TextRank, featured and including the steps as follows:
S1: generate keywords of each App according to the TextRank algorithm to form a first keywords stock;
S2: indicate a seed keyword for each sub-category according to the plurality of sub-categories;
S3: indicate a seed keyword for each sub-category according to the plurality of sub-categories;
S4: conduct full calculation for the seek keywords of all Apps under the sub-categories by the TextRank algorithm and generate the second keywords stock under a plurality of sub-categories;
S5: traverse the list of Apps again and compare the contents of each keyword with the second keywords stock in the similarity of character strings; if the similarity is lower than the preset threshold, delete the association between the Apps and the current sub-categories.

2. An application preference text classification method based on TextRank according to claim 1, featured,
the plurality of the sub-categories are the accepted 75 categories in the field of APP classification.

3. An application preference text classification method based on TextRank according to claim 1, featured,
the preset threshold is 70% or 75%.

4. An application preference text classification method based on TextRank according to claim 1, featured and further including:
S6: after traversing the list of Apps, regenerate the second keywords stock and repeat the steps S1-S5.

5. An application preference text classification method based on TextRank according to claim 4, featured and further including:
S7: check the accuracy manually according to the final generation result; if the effect is not ideal, continue to repeat the steps S1-S5.

6. (canceled)

7. (canceled)
